(19) United States
(12) Patent Application Publication
(10) Pub. No.: US 2023/0383131 A1
(43) Pub. Date: Nov. 30, 2023

(54) THREE-DIMENSIONAL PRINTED GAS BLOWN POLYSILOXANE FOAMS

(71) Applicant: Lawrence Livermore National Security, LLC, Livermore, CA (US)

(72) Inventors: Andrew Neil Mabe, Livermore, CA (US); Eric B. Duoss, Dublin, CA (US); Jeremy Lenhardt, Livermore, CA (US); Du Nguyen, Fremont, CA (US); Thomas S. Wilson, San Leandro, CA (US); Alexandra Golobic, Pleasanton, CA (US)

(21) Appl. No.: 18/226,411

(22) Filed: Jul. 26, 2023

Related U.S. Application Data
(62) Division of application No. 16/659,025, filed on Oct. 21, 2019.
(60) Provisional application No. 62/780,070, filed on Dec. 14, 2018.

(51) Int. Cl. C09D 11/102; B33Y 40/00; B33Y 80/00; B33Y 10/00; B29C 64/106; B29C 64/314; C09D 11/037; B33Y 70/00; B29K 105/04; B29K 83/00

(52) U.S. Cl. CPC C09D 11/102; B33Y 40/00; B33Y 80/00; B33Y 10/00; B29C 64/106; B29C 64/314; C09D 11/037; B33Y 70/00; B29K 2105/04; B29K 2083/00

(57) ABSTRACT

A product includes a three-dimensional printed polymer structure formed from at least one filament. The three-dimensional printed polymer structure has a plurality of layers arranged in a geometric pattern, the layers being formed from the at least one filament, where the at least one filament comprises a polysiloxane material having a plurality of closed cell pores formed therein.

### RELATED APPLICATIONS

This application is a divisional application of U.S. patent application Ser. No. 16/659,025 filed Oct. 21, 2019, which claims priority from U.S. Provisional Patent Application No. 62/780,070, filed Dec. 14, 2018. This application claims priority to the foregoing applications, each of which is also hereby incorporated by reference.

This invention was made with Government support under Contract No. DE-AC52-07NA27344 awarded by the United States Department of Energy. The Government has certain rights in the invention.

### FIELD OF THE INVENTION

The present invention relates to additive manufacturing, and more particularly, this invention relates to three-dimensional printing of gas blown polysiloxane foams.

### BACKGROUND

The technological development of additive manufacturing of advanced materials has recently gained momentum in the scientific and engineering communities. Additive manufacturing permits the development of complex architectures that are not easily achievable by conventional methods, thereby expanding the number and complexity of macroscopic properties that can be attained with simple components.

Elastomeric polysiloxanes offer significant advantages over many other engineering materials due to their resistance to chemical attack, mechanical flexibility, dielectric properties, and biocompatibility. The diverse chemistry of silicon and the great degree to which the microstructure of polysiloxanes can be controlled provide mechanisms to produce materials with a wide range of properties.

The addition of blowing agents which produce gas (such as hydrogen or carbon dioxide) into a polysiloxane resin produces a cellular, or porous, structure in the resin. The resin can be cured to maintain the cellular structure, producing a solid foam.

It would be desirable to be able to control an overall density and mechanical response of silicones by combining additive manufacturing and gas-blown foam generation.

### SUMMARY

According to one aspect of an inventive concept, a product includes a three-dimensional printed polymer structure formed from at least one filament. The three-dimensional printed polymer structure has a plurality of layers arranged in a geometric pattern, the layers being formed from the at least one filament, where the at least one filament comprises a polysiloxane material having a plurality of closed cell pores formed therein.

According to another aspect of an inventive concept, a method of forming a three-dimensional structure having closed cell pores includes selecting a first mixer speed for setting a first porosity of an ink, where the ink includes a polysiloxane having at least one vinyl group, a silane crosslinker, a catalyst, a gas blowing agent, and a thixotropic agent. Further, the method includes mixing the ink at the selected first mixer speed, extruding the ink having the first porosity at a first extrusion rate for forming a first portion of the three-dimensional structure, and curing the extruded ink in the formed three-dimensional structure to at least a predefined extent.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1A is a schematic drawing of a top view of a portion of a three-dimensional (3D) printed structure, according to one aspect of an inventive concept.

FIG. 1B is an image of a top view of a portion of a 3D printed gas blown polysiloxane foam, according one aspect of an inventive concept.

FIG. 2A is an image of a side view of a portion of a 3D printed gas blown polysiloxane structure having layers of alternating filament porosity, according to one aspect of an inventive concept.

FIG. 2B is an image of a side view of a portion of a 3D printed gas blown polysiloxane structure having a gradient of porosity, according to one aspect of an inventive concept.

FIG. 3 is a flow chart of a method for forming a 3D printed gas blown polysiloxane structure, according to an inventive concept.

FIG. 4 is a schematic drawing of a mixing system, according to one aspect of an inventive concept.

FIG. 5 is a plot of stress versus strain of a 3D printed gas blown polysiloxane structure, according to one aspect of an inventive concept.

FIG. 6 is a series of images of a side view of a portion of 3D printed gas blown polysiloxane structures formed using different mixer speeds, according to various aspects of an inventive concept.

FIG. 7 is a plot of the porosity of 3D structures by varying mixer speeds, according to one aspect of an inventive concept.

FIG. 8 is a series of images of a side view of a portion of 3D printed gas blown polysiloxane structures, with dye included in the ink, formed using different mixer speeds, according to various aspects of an inventive concept.

FIG. 9A is an image of a side view of a portion of a 3D printed gas blown polysiloxane structure having alternating sets of three layers of different porosity, according to one aspect of an inventive concept.

FIG. 9B is an image of a side view of a portion of a 3D printed gas blown polysiloxane structure having alternating sets of six layers of different porosity, according to one aspect of an inventive concept.

FIG. 9C is an image of a side view of a portion of a 3D printed gas blown polysiloxane structure having alternating sets of four layers of different porosity, according to one aspect of an inventive concept.

FIG. 10 is a series of plots of a stress versus strain of 3D printed gas blown polysiloxane structures having alternating layers of different porosity, according to one aspect of an inventive concept.

FIG. 11 is a series of plots of a stress versus strain of a 3D printed gas blow structure having a gradient of porosity, according to one aspect of an inventive concept.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

For the purposes of this application, room temperature is defined as in a range of about 20° C. to about 25° C.

As also used herein, the term “about” denotes an interval of accuracy that ensures the technical effect of the feature in question. In various approaches, the term “about” when combined with a value, refers to plus and minus 10% of the reference value. For example, a thickness of about 10 nm refers to a thickness of 10 nm±1 nm, a temperature of about 50° C. refers to a temperature of 50° C.±5° C., etc.

It is also noted that, as used in the specification and the appended claims, wt % is defined as the percentage of weight of a particular component is to the total weight/mass of the mixture. Vol % is defined as the percentage of volume of a particular compound to the total volume of the mixture or compound. Mol % is defined as the percentage of moles of a particular component to the total moles of the mixture or compound. Atomic % (at %) is defined as a percentage of one type of atom relative to the total number of atoms of a compound.

Unless expressly defined otherwise herein, each component listed in a particular approach may be present in an effective amount. An effective amount of a component means that enough of the component is present to result in a discernable change in a target characteristic of the ink, printed structure, and/or final product in which the component is present, and preferably results in a change of the characteristic to within a desired range. One skilled in the art, now armed with the teachings herein, would be able to readily determine an effective amount of a particular component without having to resort to undue experimentation.

The present disclosure includes several descriptions of exemplary “inks” used in an additive manufacturing process to form the inventive concepts described herein. It should be understood that “inks” (and singular forms thereof) may be used interchangeably and refer to a composition of matter comprising a plurality of particles coated with/dispersed throughout a liquid phase such that the composition of matter may be “written,” extruded, printed, or otherwise deposited to form a layer that substantially retains its as-deposited geometry and shape with perhaps some, but preferably not excessive, sagging, slumping, or other deformation, even when deposited onto other layers of ink, and/or when other layers of ink are deposited onto the layer. As such, skilled artisans will understand the presently described inks to exhibit appropriate rheological properties to allow the formation of monolithic structures via deposition of multiple layers of the ink (or in some cases multiple inks with different compositions) in sequence.

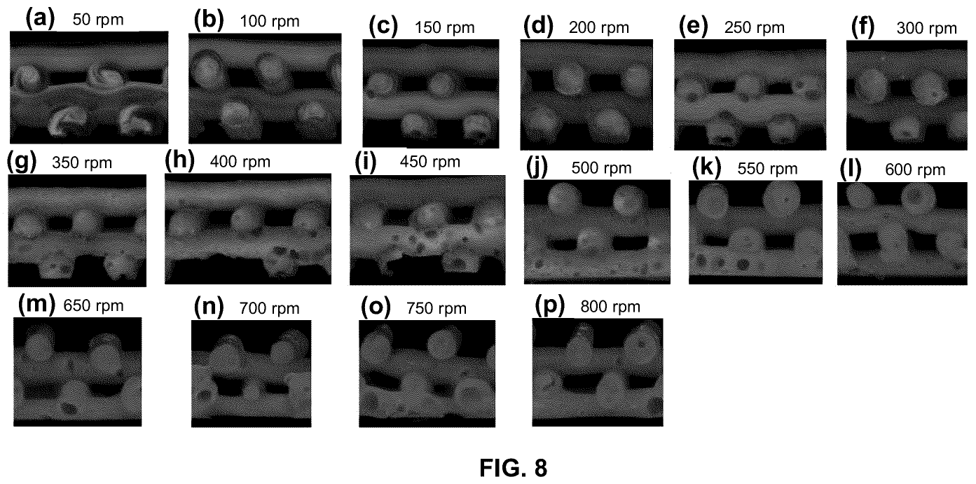

The following description discloses several preferred structures formed via direct ink writing (DIW), extrusion freeform fabrication, or other equivalent techniques and therefore exhibit unique structural and compositional characteristics conveyed via the precise control allowed by such techniques. The physical characteristics a structure formed by DIW may include having lower layers of the structure are slightly flattened, slightly disfigured from original extrusion (e.g., see slight droop of the filament in FIG. 8), etc. by weight of upper layers of structure, due to gravity, etc. The three-dimensional structure formed by DIW may have a single continuous filament that makes up at least two layers of the 3D structure.

The following description discloses several preferred embodiments of ink formulations for forming gas blown polysiloxane foams and/or related systems and methods.

In one general aspect of an inventive concept, an ink formulation for forming a gas blown polysiloxane product includes a polysiloxane having at least one vinyl group, a silane crosslinker, a catalyst, a gas blowing agent, and a thixotropic agent.

In another general aspect of an inventive concept, a product includes a three-dimensional printed polymer structure formed from at least one filament. The three-dimensional printed polymer structure has a plurality of layers arranged in a geometric pattern, the layers being formed from the at least one filament, where the at least one filament comprises a polysiloxane material having a plurality of closed cell pores formed therein.

In yet another general aspect of an inventive concept, a method of forming a three-dimensional structure having closed cell pores includes selecting a first mixer speed for setting a first porosity of an ink, where the ink includes a polysiloxane having at least one vinyl group, a silane crosslinker, a catalyst, a gas blowing agent, and a thixotropic agent. Further, the method includes mixing the ink at the selected first mixer speed, extruding the ink having the first porosity at a first extrusion rate for forming a first portion of the three-dimensional structure, and curing the extruded ink in the formed three-dimensional structure to at least a predefined extent.

A list of acronyms used in the description is provided below.
3D three-dimensional
cSt centistoke
DIW direct ink writing
ms millisecond
nm nanometer
μm micron
PDMS poly(dimethylsiloxane)
Pt platinum
Sn tin
wt % weight percent

Various aspects of an inventive concepts described herein balance the curing reactions and the hydrogen blowing reactions of a mixture to result in a foam ink for printing a three-dimensional (3D) structure. In one approach, a foam ink for 3D printing includes a metal catalyst, at 30 parts per million (ppm) or less of metal catalyst.

In other approaches, 3D printing of a foamed ink allows extrusion of a bulk foam material to print foamed struts in desired geometric patterns. A foamed ink is an ink that is a foam material before 3D printing.

According to various aspects of an inventive concept, the 3D printed foam structure may have a complex stress response from the foam material convoluted with the geometry of the printing.

According to various aspects of an inventive concept, a foamable ink has been engineered which may foam upon mixing and extrusion. In some approaches, there is the potential for the ink to foam prior to extrusion. In other approaches, causing the ink to foam may be induced primarily in a post-processing step. The pore size and distribution may be tunable. In some approaches, the ink may be a foam ink. In other approaches, the ink may be a foamable ink. In some approaches, bubble formation in the mixture can be tuned by selecting desired hydrogen blowing conditions to blow to a certain pore diameter prior to, during, and/or after extrusion through a nozzle to form a 3D structure. In some approaches, the blowing may occur during overlapping times, for example during extrusion and after extrusion. Furthermore, the engineered bubbles remain in the material after curing and correspond to the initially engineered specification.

According to one aspect of an inventive concept, an ink formulation for forming a gas blown polysiloxane product may include a polysiloxane having at least one vinyl group, a silane crosslinker, a catalyst, a gas blowing agent, and a thixotropic agent. In some approaches, the polysiloxane having at least one vinyl group may include a poly(dimethylsiloxane) (PDMS). In some approaches, the ink formulation may include a filler. In some approaches, the ink formulation may include one or more surfactants for controlling foam stability and openness.

In some approaches, the polysiloxane having at least one vinyl group may include a vinyl structure (i.e., an alkene double bond) located at one terminus of the molecule, e.g., a vinyl-terminated polysiloxane. In some approaches, the polysiloxane having at least one vinyl group may include a vinyl structure at both termini of the molecule, e.g., a divinyl-terminated PDMS. In some approaches, a polysiloxane having at least one vinyl group may include a vinyl structure located in the middle of the molecule, e.g., poly(methylvinylsiloxane-co-dimethylsiloxane), etc.

In a preferred aspect of the ink formulation, a polysiloxane having at least one vinyl group includes at least two vinyl groups. In one approach the polysiloxane having at least two vinyl groups includes a divinyl-terminated PDMS molecule.

In some approaches, a polysiloxane having at least one vinyl group may include multiple functional groups. In one approach, a vinyl-terminated polysiloxane includes at least two phenyl groups (e.g., a diphenyl vinyl-terminated polysiloxane). For example, in one approach, the polysiloxane having at least one vinyl group may include a vinyl-terminated poly(diphenylsiloxane-co-dimethylsiloxane). In one approach, the polysiloxane having at least one vinyl group may include at least two methyl groups. In some approaches, a polysiloxane having at least one vinyl group may include alternating units of phenyl groups, diphenyl groups, methyl groups, dimethyl groups, etc. on the same polymer. In one approach, the polysiloxane having at least one vinyl group includes a single phenyl group on the repeat unit, e.g., as poly(phenylmethylsiloxane-co-dimethylsiloxane).

The polysiloxane having at least one vinyl group molecules may serve as a primary base to the resin, ink formulation, etc.

In some approaches, the polysiloxane having at least one vinyl group may have a viscosity in a range of about 4 centistokes (cSt) to about 100,000 cSt. In some approaches, the vinyl-terminated polysiloxane may have a viscosity in a range of about 100 cSt to about 100,000 cSt. In preferred approaches, the vinyl-terminated polysiloxane may have a viscosity in a range of about 1,000 cSt to about 50,000 cSt. In an exemplary approach, a vinyl-terminated polysiloxane may have a viscosity in a range of 1,000 cSt to about 10,000 cSt.

In various approaches, the mixture may include a combination of vinyl-containing PDMS molecules.

In some approaches, diphenylsiloxane or other phenylated siloxane may be incorporated as a copolymer with vinyl-terminated PDMS in an effective amount to suppress crystallinity. In other approaches, diphenylsiloxane-containing polymers may be added separately to the mixture in an effective amount to suppress crystallinity. In other approaches, diphenylsiloxane may be incorporated as a small molecule such as diphenylmethylvinylsilane, diphenylmethylsilanol, etc.

In some approaches, a concentration of vinyl-terminated polysiloxane may be in a range of about 45 wt % to 80 wt % of total mixture.

In some approaches, a silane crosslinker may be any silane-containing molecule, polymer, or copolymer where the polymer functionality (e.g., silane functionality) is greater than 2. Some exemplary examples of silane crosslinker include poly(hydrogen methyl siloxane), poly(dimethylsiloxane-co-hydrogen methyl siloxane), silane, methyl silane, etc. In some approaches, a silane crosslinker includes an elastomer.

In some approaches, a concentration of silane crosslinker may be in a range of about 0.1 wt % to about 50 wt % of total ink formulation. In one approach, a concentration of silane crosslinker may be in a range of about 1.5 wt % to about 20 wt % of total ink formulation. In preferred approaches, a concentration of silane crosslinker may be in a range of about 4 wt % to about 20 wt % of total ink formulation.

In some approaches, either monofunctional or difunctional silanes may be incorporated. These may be used to decrease viscosity of the matrix, to control hardness of the final cured material, and/or to serve as sources of hydrogen in addition to the silane crosslinker.

In some approaches, isocyanate-containing PDMS molecules may be used to provide a source of carbon dioxide. In one exemplary approach, an isocyanate-terminated PDMS may be included in the ink formulation.

In various aspects of one inventive concept, the catalyst of the ink formulation may include a metal catalyst and/or a free radical catalyst. In some approaches, a metal catalyst may be included to catalyze the curing and hydrogen-blowing reactions. Exemplary metal catalysts include Pt, Ir, Sn, Rh, and others known to those skilled in the art.

In some approaches, a concentration of the metal catalyst may be in a range of 1 parts per million (ppm) to about 100,000 ppm of the ink formulation. In preferred approaches, the concentration of a Pt metal catalyst may be in a range of between 1 parts per million (ppm) to about 1000 ppm in terms of mass of Pt per mass of the ink. More preferably between 5 ppm and 500 ppm, and most preferably between 10 ppm and 100 ppm.

In one approach, the concentration of a Sn metal catalyst may be up to 100,000 ppm of the ink. In preferred approaches, the concentration of a Sn metal catalyst may be up to 50,000 ppm of the ink.

In some approaches, the ink may include a free-radical catalyst for crosslinking reactions during the curing reactions. Examples of free radical catalysts include thermally activated or ultraviolet-activated free radical precursors, including but not limited to benzoyl peroxide, azobisisobutyronitrile, and commercially available agents such as Darocur® compound series (Sigma-Aldrich Chemicals, St. Louis, MO). In one approach, a concentration of the free radical catalyst may be in a range of about 0.01 wt % to about 5.0 wt % of total weight of the ink.

In some approaches, a gas-blowing agent may include any reagent with an —OH group. In some approaches, the gas-blowing agent may be a hydrogen blowing agent. In one approach, hydrogen-blowing agents may include a monofunctional gas blowing agent. In another approach, the hydrogen-blowing agent may be a multifunctional silanol, alcohol, carbinol, water, etc. In preferred approaches, a monofunctional silanol, carbinol terminated polysiloxane, etc. may be included to react with a silane in the presence of a metal catalyst to produce hydrogen gas, carbon dioxide gas, etc. A multi-functional silanol, alcohol, etc. may be preferable for a mixture for stiffening the mixture.

In other approaches, the gas blowing agent may be a carbon dioxide blowing agent. In the presence of isocyanates, water is the preferred carbon dioxide blowing agent.

In some approaches, the gas blowing agent may be a nitrogen gas blowing agent.

In a preferred approach, a small molecule hydrogen blowing agent is included in the mixture, e.g., a small molecule, a monomer, a macromer, etc. but not a polymer. For example, a preferred small molecule silanol hydrogen blowing agent includes trimethylsilanol or diphenylmethylsilanol that reacts and forms a stable bond without forming defects with the other polymer components of the mixture. In particular, the one —OH group of the trimethylsilanol allows specificity of the hydrogen blowing agent to the material. The remaining small chain of the trimethylsilanol molecule is unreactive with the material and limits defect effects that might weaken the material.

In some approaches, it may be preferable not to use large molecules of organopolysiloxane as a hydrogen blowing agent. In some instances, large molecules of organopolysiloxanes having single reactive groups may form defects in the material. In one approach, a polymer may be included as a blowing agent. In preferred approaches, a smaller molecule blowing agent may provide enhanced mechanical properties. For example, in some instances, larger molecule polymers may introduce defects in the material that may diminish the mechanical properties of the foam.

In some approaches, a concentration of gas blowing agent may be in a range of about 0.1 wt % to 90 wt % of the total mixture. In preferred approaches, the gas blowing agent may be in a range of about 3 wt % to about 15 wt % of the total weight of ink.

In some approaches, a thixotropic agent may include any small molecule, polymer, copolymer, solution, etc. that imparts shear-thinning properties to the polysiloxane resins for 3D printing. In preferred approaches, thixotropic agents may include silicon polyethers, ethoxylated, propoxylated poly(dimethyl siloxane), etc.

In some aspects of one inventive concept, a rheology modifying additive may be added to impart pseudoplasticity. Rheology modifying additives impart thixotropy in polysiloxane materials.

In preferred approaches, adding certain thixotropic agents to silica-loaded polysiloxanes imparts direct ink writability. In preferred approaches, a silicone polyether copolymer may be included as a thixotropic agent in the mixture. When added to polysiloxane resins containing gas blowing agents, foaming can occur in the thixotropic resin, then the foamed resin can be printed. The resulting foamed, printed resin can then be cured by thermal treatment to produce the desired material.

In some approaches, a concentration of thixotropic agent may be in a range of about 0.1 wt % to about 3.0 wt % of total mixture, but may be higher or lower. In preferred approaches, the concentration of thixotropic agent is in a range of 0.2 wt % to about 1.0 wt % of the total mixture. In an exemplary approach, the concentration of thixotropic agent is in a range of 0.2 wt % to 0.5 wt % of the total mixture.

In some approaches, the polysiloxane oligomer molecular weight and chain architecture may be optimized to simultaneously allow direct ink writing (DIW) printing as well as regulate foam formation. In these approaches, a broad molecular weight distribution polymer, e.g., long chain branching or star chain architectures may be used to regulate the size and size distribution of porosity from blowing. In some approaches, the ink formulation may include a polymer for broadening the polysiloxane resin architecture to control foaming of the ink. In one approach, the polymer may include a broad molecular weight distribution polymer, e.g., a long chain branched polymer. In one approach the polymer may include a star polymer.

In some approaches, the ink formulation may include at least one additive of the following: an inhibitor, a surfactant, a filler, a stiffening agent, a color dye, etc., preferably present in an effective amount to provide the desired characteristic of the ink, printed structure, and/or final product.

In some approaches, the metal catalyst reactions can be affected by appropriate use of inhibitors, including but not limited to alkyne-ol (i.e., an acetylenic alcohol), preferably an α-acetylenic alcohol, vinyl-containing cyclic siloxanes, and other inhibitors known to those skilled in the art.

In various approaches, the concentration of inhibitors may be in a range of 10 ppm to 10,000 ppm. The concentration of inhibitor may be typically greater than the concentration of metal catalyst in the mixture.

In some approaches, the ink formulation may include surfactants for improving the stabilization of the gas blown bubbles within the ink. Exemplary examples of surfactant include fluorinated and perfluorinated alkanes, fluorinated and perfluorinated alkyl silanes, fluorinated and perfluorinated polysiloxanes, fluoroalkyl- and perfluoroalkyl-containing polysiloxanes, etc. can be used to enforce cell size and geometry. Examples of surfactants include, but not limited to, 1H,1H,2H,2H-perfluorooctylsilane; 1H,1H,2H,2H-perfluorohexylsilane; 1H,1H,2H,2H-perfluorooctyl-terminated poly(dimethylsiloxane); 1H,1H,2H,2H-perfluorooctyl-terminated poly(dimethylsiloxane). In various approaches, preferred surfactants have a perfluoroalkyl group and a siloxane group.

In some approaches, the filler additive may include a reinforcing filler for reinforcing the printed structure, e.g., to provide durability to the printed structure. In some approaches, the filler additive may include a non-reinforcing filler for increasing the volume of the ink formulation. In some approaches, the filler additive may include an extending fillers for extending the polysiloxane of the ink. Exemplary fillers include fumed silicas, precipitated silicas, diatomaceous earth, calcium carbonate, etc.

In approaches, a concentration of filler may be less than about 30 wt %, preferably up to about 20 wt % of total mixture, but may be more or less. In various approaches, the concentration of filler may be determined by the filler included in the mixture. In one preferred approach, a filler may have a maximum reinforcement effect at 20 wt %, so then 20 wt % is the desired concentration of the filler in the mixture.

In some approaches, the ink formulation may include a stiffening agent. In an exemplary approach, the stiffening agent includes a resinous silica, for example, MQ, MT, etc. In one approach, the resinous silica may be used as a filler additive. Resinous silica are small silica particles having reactive functional groups, e.g., phenyl groups, vinyl groups, etc. Resinous silica has a low viscosity that allows incorporation into the material without increasing viscosity, and the high density of reactive groups makes the resulting material stiffer. In some approaches, the concentration of resinous silica may be in a range of about 1 wt % to about 50 wt % of total mixture. In preferred approaches, the concentration of resinous silica may be in a range of about 5 wt % to about 20 wt % of total mixture.

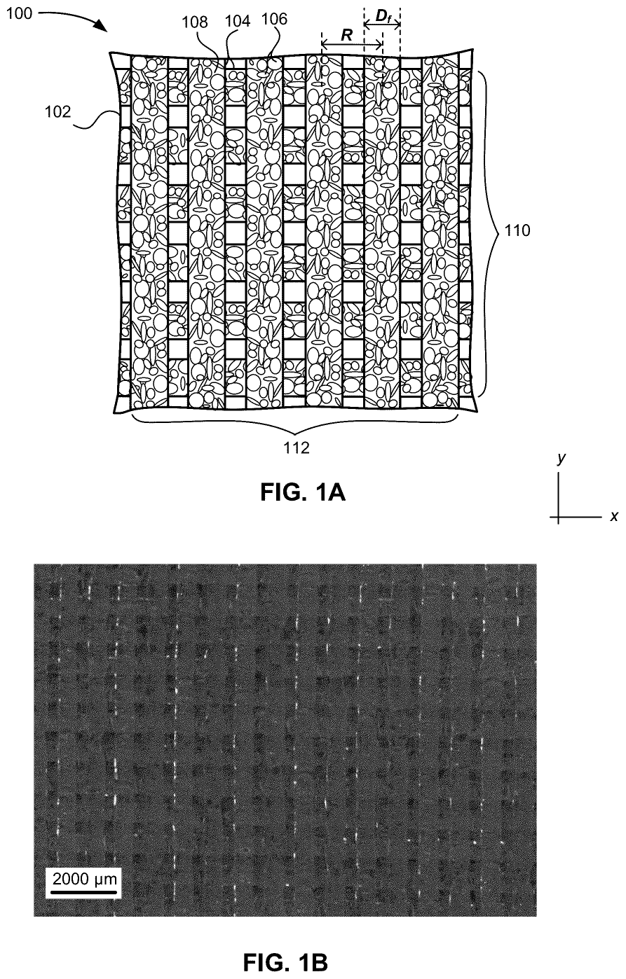

FIG. 1A depicts a schematic diagram of a top view of a portion of a product 100, in accordance with one aspect of an inventive concept. As an option, the present product 100 may be implemented in conjunction with features from any other inventive concept listed herein, such as those described with reference to the other FIGS. Of course, however, such product 100 and others presented herein may be used in various applications and/or in permutations which may or may not be specifically described in the illustrative embodiments listed herein. Further, the product 100 presented herein may be used in any desired environment.

In one approach, a product 100 includes a 3D printed polymer structure 102 formed from at least one filament 104. The 3D printed polymer structure 102 has a plurality of layers 110, 112 arranged in a geometric pattern. The layers 110, 112 may be formed from the at least one filament 104. In one approach, the layers may be formed from at least one continuous filament.

The at least one filament 104 includes a polysiloxane material 108 having a plurality of closed cell pores 106 formed therein. The closed cells pores 106 are gas bubbles that are created during formation of the filament 104. The closed cell pores 106 do not have an outer shell. The interior surfaces of the closed cell pores are defined by the bulk material of the filament. As shown in the portion of the product 100, the closed cell pores 106 are formed from gas bubbles having variable sizes. Closed cell pores may be defined as pores being closed to fluid.

According to one aspect of an inventive concept, a 3D printed polymer structure is a 3D printed lattice with foamed strands in which the lattice is open cell foam structure, while the filaments, strands, etc. have closed cell pores therein. In some approaches, by adjusting the speed of the mixer of the ink prior to extrusion of strands, filaments, etc., the closed cell contribution to porosity may be modified by changing the mixer speed.

In one approach, and not meant to be limiting in any way, a 3D printed lattice with filaments, where the filaments have a plurality of closed cell pores therein may be represented by the image of FIG. 1B.

As shown in the schematic drawing of FIG. 1A, the geometric pattern (e.g., lattice) of the layers of the 3D printed polymer structure 102 may increase the overall porosity of the 3D printed polymer structure 102, e.g., an open cell foam, see Equation 1.

$$\% Porosity of 3 D strcture = ( \frac{R - {D}_{f}}{R} ) \times 100 \qquad Equation 1$$

where D_{f} is defined as the diameter of the filament, and R is defined as the center-to-center spacing between two adjacent filaments. In one approach, a porosity of the 3D printed lattice being an open cell foam structure may be greater than 74%. The porosity of the printed 3D structure may be tailored by changing the print geometry. For example, tuning the ink with increased thixotropy may improve the porosity of the 3D structure to greater than 74%.

In some approaches, the Total Porosity of a 3D printed polymer structure includes the volume fraction of voids in the total volume of the structure, including the open cells from the printed geometric lattice pattern and the closed cell pores in the filaments forming the lattice pattern. In some approaches, a Total Porosity of a 3D printed gas blown polysiloxane structure may be in a range of about 21% to about 95% porosity, in which porosity may be defined as volume fraction of void space over the total volume.

The Total Porosity (P_{Total}) of a 3D printed polymer structure having filaments with close cell pores may be determined by calculating the density of a part of the structure (e.g., a punched portion), and measuring the mass (e.g., weighing the structure) and the volume of the 3D structure.

$${P}_{Total} = ( \frac{( {ρ}_{ink} - {ρ}_{foam} )}{{ρ}_{ink}} ) \times 100 where , \qquad Equation 2$$

$${ρ}_{foam} = \frac{{Mass}_{foam}}{{Volume}_{foam}} \qquad Equation 3$$

the Total Porosity of the 3D printed structure may be calculated from the density of the foam (ρ_{foam}) and the density of the ink (ρᵢₙₖ) as shown in Equation 2.

In another approach, if the structural porosity (Pₛ) and filament porosity (P_{f}) are known, the Total Porosity (P_{Total}) may be calculated using Equation 4,

P_{Total}=(Pₛ+P_{f})−(Pₛ×P_{f}) Equation 4

In a preferred aspect of an inventive concept, 3D printing of a foamable ink allows extrusion of a bulk material to print foam struts in desired geometric patterns. A foamable ink may be defined as an ink that forms a foam structure before, during, and/or after a 3D printing process. For example, the foamable ink may be printed into a 3D geometric pattern generating a foam structure having foam filaments, foam strands, etc.

Moreover, in one approach, the volume of void space of the printed geometry of the 3D structure may be defined by open-cell pore volume (V_{OCP}) of which the open cell pores (OCP) come solely from the printed geometry of the structure. The volume of void space of the closed cells of the filaments may be defined by closed cell pore volume (V_{CCP}), where the closed cell pores (CCP) refer to the bubbles within the filaments formed from the foaming action. Total volume (V_{T}) of the printed 3D structure may be calculated as the total volume according to the outer dimensions of the printed 3D structure.

Printed Porosity of a printed 3D structure may be calculated using Equation 5,

$$Printed Porosity = ( \frac{{V}_{OCP}}{{V}_{T}} ) \times 100 \qquad Equation 5$$

In some approaches, total porosity of a 3D printed structure may be calculated from Equation 6,

$$Total Porosity = \frac{( {V}_{OCP} + {V}_{CCP} )}{{V}_{T}} \times 100 \qquad Equation 6$$

According to one aspect of an inventive concept, a 3D printed polymer structure may include a plurality of layers in which each layer is formed from the at least one filament (e.g., a first layer, a second layer, a third layer, etc.). In one approach, the filament may be a continuous filament forming all the layers of the structure. In one approach, the filament of the first layer has a first porosity, and the filament of the second layer has a second porosity, where the first and second porosity are different.

In one approach, the composition of the material of the filament for the first layer, second layer, third layer, etc. may be the same. The ink forming the extruded filament of the 3D printed polymer structure may remain the same for the duration of the printing of the entire structure. In one approach, the composition of the material for each layer may be different. In one approach, the pattern of porosity in each of the layers may be different while the composition of each layer is the same. In another approach, the porosity in each of the layers of the structure may be the same while the composition of each layer is different.

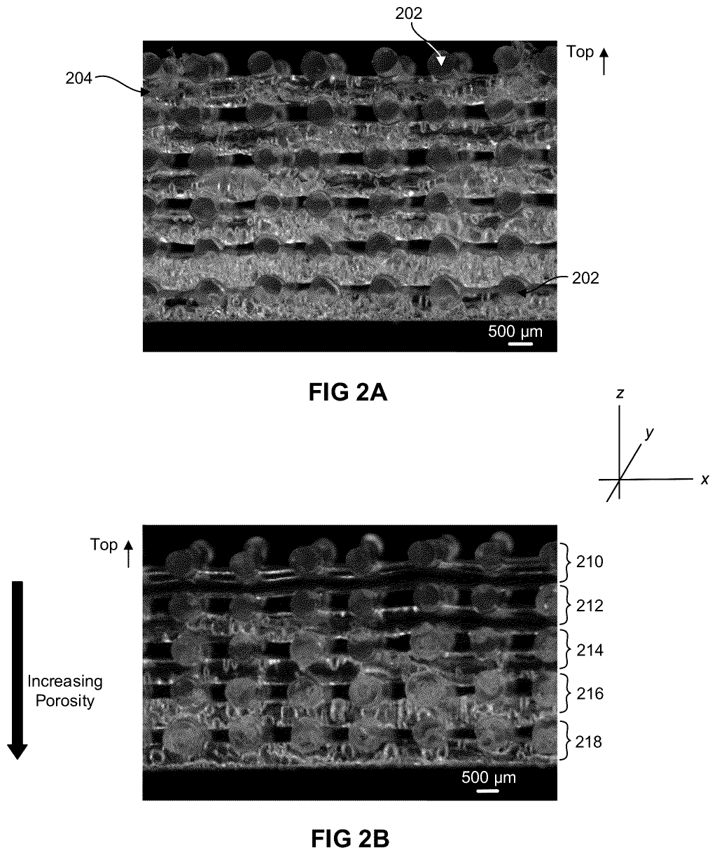

For example, and not meant to be limiting in any way, FIG. 2A is an image of a side-view of a portion of a 3D printed polymer structure, according to one approach. The 3D printed polymer structure as shown in FIG. 2A includes alternating layers stacked in a z-direction having filaments of different porosity. As an example of different porosity, the uppermost layer 202 in the image (i.e., nearest the Top of the image) in which the printed filaments are parallel to the y-direction (i.e., facing the page) include a filament (more than one filament, a series of filaments, etc.) that has essentially no closed cell pores, very low porosity, etc. The adjacent layer 204, directly under the uppermost layer 202 and alternating thereafter, in which the filaments have a plurality of closed cell pores, high porosity, etc.

In one approach, the 3D printed polymer structure may have a gradient of porosity resulting from each of the layers having a different filament porosity. As illustrated in FIG. 2B, and not meant to be limiting in any way, a 3D printed polymer structure has a gradient of porosity where every two layers has a different porosity. As shown, each set of two layers has one layer having filaments printed in a direction parallel to the y-axis, and a second layer having filaments printed in a direction parallel to the x-axis (i.e., perpendicular to the y-axis). The uppermost set of two layers 210 (relative to the Top of the image) includes filaments that have essentially no closed cell pores, very low porosity, etc. The adjacent set of two layers 212 includes filaments having a few closed cell pores, a low porosity, etc. The following sets of layers 214, 216, 218 have filaments with increasing porosity, in which the first set of layers 218 at the bottom of the image have the highest porosity.

In some approaches, the 3D printed polymer structure has a varying degree of stiffness in an x-y direction and/or a z-direction thereacross, e.g., the entire structure. In some approaches, a stress response of the 3D printed polymer structure at different strains may be tuned, engineered, designed, etc. according to the porosity of the extruded ink of the structure. In some approaches, a stress response of the 3D printed polymer structure at different strains may be tuned, engineered, designed, etc. according to the printing geometry.

According to one aspect of an inventive concept, methodology for creating a 3D printed gas-blown polysiloxane foams is described. Polysiloxane foam formulations are generally known, but these materials have not yet been applied to 3D printing.

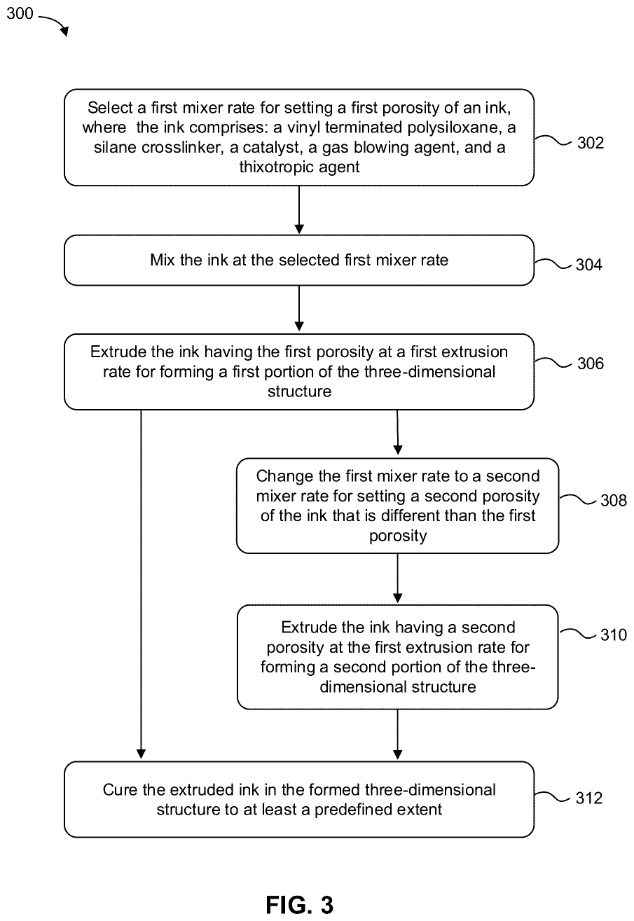

FIG. 3 shows a method 300 for forming a 3D structure having closed cell pore, in accordance with one aspect of one inventive concept. As an option, the present method 300 may be implemented to construct structures such as those shown in the other FIGS. described herein. Of course, however, this method 300 and others presented herein may be used to form structures for a wide variety of devices and/or purposes which may or may not be related to the illustrative embodiments listed herein. Further, the methods presented herein may be carried out in any desired environment. Moreover, more or less operations than those shown in FIG. 3 may be included in method 300, according to various embodiments. It should also be noted that any of the aforementioned features may be used in any of the embodiments described in accordance with the various methods.

A method 300 as shown in FIG. 3 of forming a 3D polymer structure is highly scalable and compatible with additive manufacturing (e.g., three-dimensional (3D) printing) methods such as direct ink writing (DIW) and projection micro-stereolithography (PμSL). In various approaches, the product has physical characteristics of formation by an additive manufacturing technique. In various approaches, physical characteristics may include filaments arranged in a geometric pattern, a patterned outer surface defined by stacking filaments, a defined porosity (e.g., ordered, controlled, non-random, etc.), a porosity having pores with measurable average diameters, etc. Thus, using these additive manufacturing techniques allows engineering of parts and production of optimal geometry for efficient mass transport and mechanical strength.

Method 300 begins with step 302 of selecting a first mixer speed for setting a first porosity of an ink. A mixer speed may also be defined as a mixer rate. In one approach, the ink includes a vinyl terminated polysiloxane, a silane crosslinker, a catalyst, a gas blowing agent, and a thixotropic agent, as described herein. In one approach, the ink is a foam ink.

Various aspects of an inventive concept describe an ink for additive manufacturing (e.g., DIW) that includes addition of gas blowing agents to polysiloxane resins to produce gas bubbles inside the resin, thereby resulting in closed-cell pore structure within the resin. In one approach, addition of hydrogen blowing agents to polysiloxane resins may produce hydrogen gas bubbles inside the resin. In another approach, addition of carbon dioxide blowing agent to polysiloxane resins may produce carbon dioxide gas bubbles inside the resin. In another approach, addition of nitrogen blowing agent to polysiloxane resins may produce nitrogen gas bubbles inside the resin. Furthermore, addition of thixotropic agents to the mixture induces shear-thinning behavior that imparts direct ink write-ability to the polysiloxane resin.

In various approaches, the properties of a gas-blown foam can be modified by changing the size, number, and shape of the pores, as well as modifying the properties of the surrounding cured resin. For example, density can be decreased by increasing the amount of blowing agent; shape can be controlled by addition of surfactants; stiffness can be controlled by the molecular weight of the polysiloxane chains in the resin, by addition of resinous silica, etc.

The surface energy is high between the polysiloxane material and the surrounding air, thus the addition of surfactants to the polysiloxane materials may enable the surface area to be energetically favorable to receive the bubbles, to allow diffusion of the bubbles, to allow expansion of the bubbles in the material, prevent coalescence or ripening of the bubbles, etc. The surfactant may lower the surface energy of the polysiloxane material to allow diffusion and stabilization of the hydrogen bubbles. Moreover, surfactants may stabilize the bubbles to remain spherical.

In one approach, the mixture may be formed in a two-part system. For example, the two parts, Part A and Part B, may be formulated as listed in Table 1. In preferred approaches, the viscosity of Part A and the viscosity of Part B are similar prior to combining the two parts to form the foam mixture. The criteria for forming Part A and Part B include a) separating the silane cross-linker and metal catalyst in different parts as these two components may be reactive, e.g., the silane may deactivate the catalyst, or in the presence of

TABLE 1
Example 1 of Formulation for a Foam Ink

| Part A | Part B | Comment |
|---|---|---|
| Divinyl | Divinyl | Could be the same or different |
| PDMS | PDMS | |
| | Silane | Reactive with metal catalyst, silanol |
| | Cross-linker | |
| Metal catalyst | | Reactive with Silane Cross-linker |
| Resinous | | |
| Silica | | |
| Filler | Filler | May be present in part A and/or Part B |
| Silanol | | Spontaneously reactive with Silane |
| | | Cross-linker |
| | Surfactant | May be present in part A and/or Part B |
| | Inhibitor | Reactive to Metal Catalyst |
| | | (inhibits activity) |
| Thixotropic | Thixotropic | Preferably added to Part having Filler |
| Agent | Agent | |

a vinyl species, the silane may cause curing, and b) separating the inhibitor and the metal catalyst. In some approaches, it may be desirable to separate the silanol and the silane cross-linker which are spontaneously reactive. In some approaches, filler may be included in Part A and/or Part B.

In preferred approaches, filler in each part improves mixing of the two parts. In preferred approaches, the filler and thixotropic agent included together in a Part of the mixture. For example, if filler is only in Part A, then the thixotropic agent is added to Part A. In another example, if both Part A and Part B include a filler, then both Part A and Part B include a thixotropic agent (as shown in Table 1).

TABLE 2
Example 2 of Formulation for a Foam Ink

| Part A | Part B | Comment |
|---|---|---|
| Divinyl | Divinyl | Could be the same or different |
| PDMS | PDMS | |
| | Silane | Reactive with metal catalyst, silanol |
| | Cross-linker | |
| Metal catalyst | | Reactive with Silane Cross-linker |
| Filler | Filler | May be present in part A and/or Part B |
| | Silanol | Spontaneously reactive with Silane |
| | | Cross-linker |
| | Surfactant | May be present in part A and/or Part B |
| Thixotropic | Thixotropic | Preferably added to Part having Filler |
| Agent | Agent | |

In various approaches, the surfactant may be added to either Part A and/or Part B. In a preferred approach, if the surfactants include silanes, then the surfactant is added to the Part that includes the silane cross-linker, as shown in Part B, Table 1 and Table 2.

In an exemplary approach, two parts, Part A and Part B, may be formulated listed as Example 2 in Table 2. Part A may include a divinyl PDMS, metal catalyst, filler and a thixotropic agent. Part B may include a divinyl PDMS, silane crosslinker, filler, silanol, surfactant, and thixotropic agent. In one approach, filler may not be included in Part A and Part B.

The silanol and silanes are spontaneously reactive, but the reaction is slow. In one approach, the silanol may be included in the part with the silane cross-linker. In one approach, formulating the silanol in the same part as the silanes allows these components to be thoroughly combined prior to printing, thereby promoting enhanced foaming. In preferred approaches, Part B including the silane cross-linker and silanol are combined at least 24 hours prior to printing. In another approach, the silanol may be in the part without the silane cross-linker.

In an exemplary approach, the two parts are mixed in the nozzle of the 3D printing process, e.g., the nozzle of the direct ink writing process. In some approaches, the mixing of Part A and Part B occurs just prior to extrusion through the nozzle during printing of a 3D structure. In a preferred approach, the mixing of Part A and Part B occurs concurrent with extrusion of the mixture through the nozzle during printing of a 3D structure using direct ink writing techniques.

In some approaches, a method for forming a 3D printed polysiloxane gas blown foam includes forming a 3D printed part by extruding the foamed or foamable mixture as an ink through the nozzle during direct ink writing processes, and curing the 3D structure. In some approaches, the 3D printed structure is cured following the printing step. The curing step includes heating the printed structure at a temperature in a range of room temperature to about 150° C. for a duration of time. In an exemplary approach, the curing includes heating the structure to 150° C. for 16 hours. Temperatures higher than 220° C. may induce decomposition of the material in the structure.

In various approaches, the mixture may be combined at room temperature. In some instances, temperature may vary as determined by the component of the mixture as generally understood by one skilled in the art.

In various approaches, the mixer speed of the ink in a mixing system may be defined as the speed of mixing the ink in a nozzle, cartridge, etc. prior to extruding the ink to a substrate. The speed is measured in revolutions per minute of a paddle, impeller, stirring rod, etc. In one approach, selecting a mixer speed for setting a porosity includes determining the viscosity of the ink, parts of ink, etc. The change in porosity with mixing speed may be a function of adequacy of mixing as well as heat generation. The heat generation may be a function of viscosity and mixing rate. Changing the temperature affects the relative reaction rates of gas generation and crosslinking, thereby affecting the porosity of the ink. The viscosity of the ink may be a “tuning dial” for bubble size therein and stiffness of the filament material. Porosity may be tuned by the amount of blowing agent, the amount of silane, the amount of surfactant, the degree of mixing, and the heat generation.

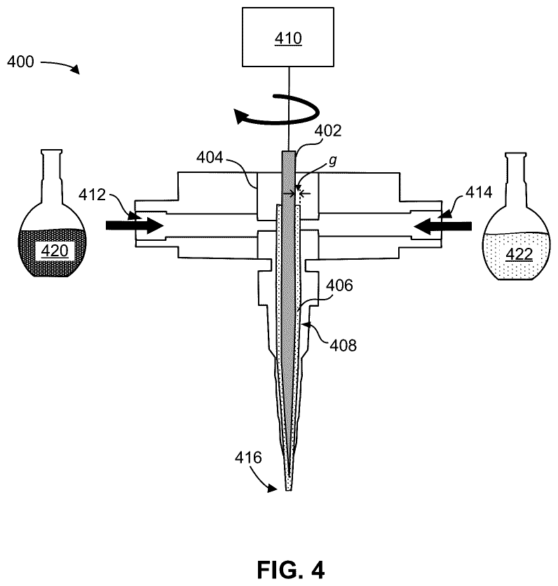

As illustrated in FIG. 4, in one approach, a mixing system 400 may provide a mixer speed for mixing the ink for forming a 3D structure as described herein. A mixing impeller 402 may be driven by a rotary motor 410. The rotary motor 410 may turn the mixing impeller 402 (direction of arrow) at speeds of 10 revolutions per minute (rpm) to 600 rpm. The mixing impeller 402 is inserted into a stationary mixing body 404 having two inlets 412, 414 for two inks (e.g., two parts of one ink, two different inks, etc.). The mixing body 404 also sets the gap g between the mixing impeller 402 and the inner surface wall 408 of the mixing body 404. In preferred application, the gap g may be around 140 μm and provides the primary mixing region 406 (e.g., mixing volume) for the inks. In preferred approaches, the mixing region 406 has a high shear energy generated by the applied shear force of the mixing impeller 402 as the inks flow down through the mixing region 406 to the nozzle outlet 416 thereby mixing of shear thinning inks.

Referring back to FIG. 3, step 304 of method 300 includes adding an ink to a cartridge, nozzle, mixing body, etc. having a mixer therein for mixing the ink at the selected first mixer rate. As illustrated in the mixing system 400 of FIG. 4, in one approach, part A 420 of an ink may be added by inlet 412 and part B 422 of an ink may be added by inlet 414 to the mixing region 406 having a mixing impeller 402 therein for mixing the ink at a first mixer rate.

Referring back to FIG. 3, step 306 includes extruding the ink having the first porosity from the mixing system, nozzle, cartridge, etc. at a first extrusion rate for forming a first portion of the 3D structure.

In one approach, the entire 3D structure may be formed with an ink having a porosity determined by a single mixer rate. In one approach, extruding the ink having the first porosity of step 306, may be followed by step 312 of curing the extruded ink in the formed 3D structure to at least a predefined extent. In various approaches, the 3D printed structure of siloxane-based ink may be cured according to the curing agent present in the ink. In some approaches, the temperature may be raised in order to initiate curing. In other approaches, free radical chemistry may be used to initiate curing of the printed structure. In one approach, the temperature may be raised to effect free radical curing of the printed structure. In one approach, UV irradiation may be used to initiate curing of the printed structure. In various other approaches, curing may be initiated by methods known by one skilled in the art.

In one aspect of the inventive concept, the step of extruding the ink having the first porosity may be followed by step 308 that includes changing the first mixer speed to a second mixer speed for setting a second porosity of the ink that is different than the first porosity. In another approach, a composition of the ink may be changed to a second composition having a different composition to form closed cell pores in the extruded ink when mixed at the first mixer speed.

Step 310 includes extruding the ink having a second porosity from the cartridge, nozzle, mixing system, etc. at the first extrusion rate for forming a second portion of the three-dimensional structure. In one approach, the first portion and the second portion may have higher and lower porosities relative to each portion. In one approach, the first portion may be a first layer and the second portion may be a second layer above the first layer in a z-direction across the 3D structure. Looking to FIG. 2A, a structure illustrated in the image shows the formation of a first layer having one filament porosity and a second layer formed above the first layer, where the second layer has a different filament porosity from the first layer.

In one approach, forming the 3D structure may include an alternating pattern of first and second portions extruded in a x-y direction and/or z-direction thereacross. In one approach, a first and second layer having different filament porosities may be formed from extrusion of a continuous filament where the mixer speed of the mixing system is changed for each layer (higher, lower, higher, lower, etc.). In one approach, a first portion may include 2, 3, 4, 5, 6, etc. layers having a first filament porosity and a second portion may include 2, 3, 4, 5, 6, etc. layers having a second filament porosity. A 3D structure may be formed by extrusion where the first and second portions are alternated. For example, and not meant to be limiting in any way, in one approach, a 3D structure may be formed having 2 layers of first filament porosity, 2 layers of second filament porosity, 2 layers of first filament porosity, etc. In another approach, a 3D structure may be formed having 3 layers of first filament porosity, 3 layers of second filament porosity, 3 layers of first filament porosity, etc. In yet another approach, a 3D structure may be formed having 4 layers of first filament porosity, 4 layers of second filament porosity, 4 layers of first filament porosity, etc.

In one approach, the first and the second portions may form a gradient of porosity in the 3D structure, where the composition of the first and second portion is the same. In one approach, the gradient of porosity may be formed in a step-wise pattern of a plurality of portions having different porosities. Looking to FIG. 2B, a structure illustrated in the image shows the formation of a gradient of porosity in the formed 3D structure, where a first portion has one filament porosity and a second portion formed above the first portion has a different filament porosity from the first layer. The composition of the filaments of the first and the second portion is the same.

Referring back to FIG. 3, following extrusion of ink at the first and/or second porosity, step 312 of method 300 includes curing the extruded ink in the formed three-dimensional structure to at least a predefined extent as described herein.

In one approach, the closed cell foam is formed from a foam ink, then the foam ink may be printed into a 3D structure, followed by curing of the 3D printed structure. In other aspects of an inventive concept, the ink is formed from a foamable composition which may be printed into a 3D structure, followed by foaming and curing. In one approach, a hierarchical foam may be formed with the material of the structure being a foam before printing, and the printing process forming a geometric struts that generate a foam structure.

In various aspects of an inventive concept, the resin mixture may be used as an ink to print a 3D structure that subsequently cures after printing to produce a porous solid that includes void spaces created by the 3D printing process. In one approach, the resin mixture is a foamed resin mixture. In another approach the resin mixture is a foamable resin mixture. In some approaches, the resulting structure is a material with dynamic, controllable stress responses and lower average densities than is normally achievable by hydrogen-blowing foam formation alone.

Experiments

Stress Versus Strain of 3D Printed Gas Blown Polysiloxane Structure

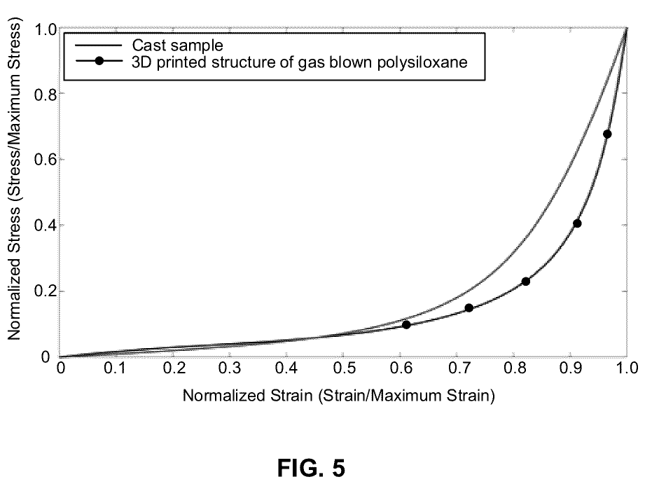

A 3D printed gas blown polysiloxane structure formed with a high mixer speed during mixing and extrusion demonstrates decreased stress with increase strain compared to a cast sample formed from a mold of the gas blown polysiloxane ink without mixing. As shown in FIG. 5, the 3D printed structure of a gas blown polysiloxane ink at a mixer speed of 450 rpm during extrusion (●) demonstrates less stress with increased strain compared to a cast sample of a gas blown polysiloxane ink poured into a mold, without mixing.

Effect of Mixer Speeds on Filament Porosity

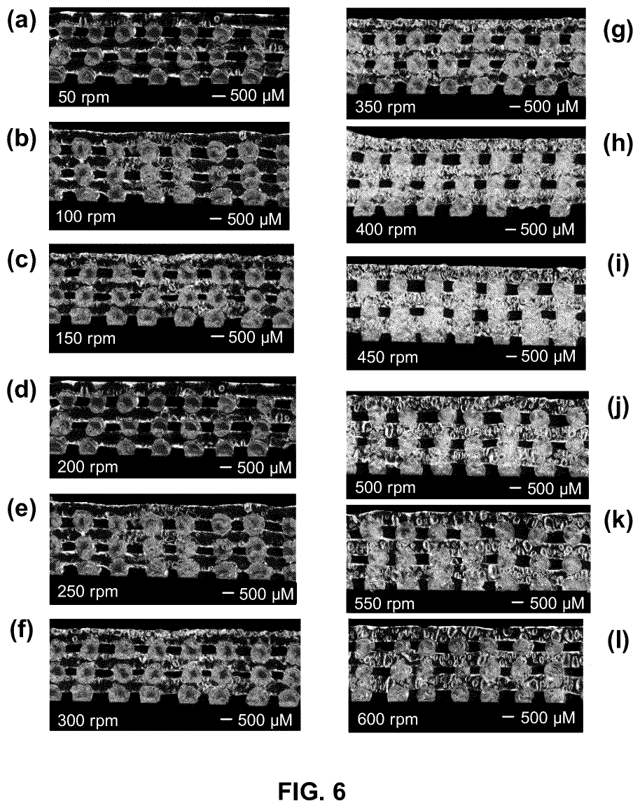

Increasing mixer speed during extrusion of the gas blown polysiloxane demonstrates a pattern of porosity in the extruded filament. The images of FIG. 6 represent a side view of a portion of 3D printed structures using gas blown polysiloxane ink extruded during different mixer speeds. Part (a) is an image of a 3D printed structure formed using a 50 rpm mixer speed. The porosity of the filaments with an ink mixed at 50 rpm has essentially no bubbles, and hence very low porosity. The following images depict 3D printed structures formed using a gas blown polysiloxane ink with different mixer speeds: (b) a mixer speed of 100 rpm, (c) a mixer speed of 150 rpm, (d) a mixer speed of 200 rpm, (e) a mixer speed of 250 rpm, (f) a mixer speed of 300 rpm, (g) a mixer speed of 350 rpm, (h) a mixer speed of 400 rpm, (i) a mixer speed of 450 rpm, (j) a mixer speed of 500 rpm, (k) a mixer speed of 550 rpm, and (l) a mixer speed of 600 rpm. The porosity of the filaments of the 3D printed structures increases with increased mixing speed up to about 400 rpm to 450 rpm. At mixing speeds above 450 rpm, the porosity of the filaments of the 3D printed structures decrease (see images of parts (j), (k), and (l)).

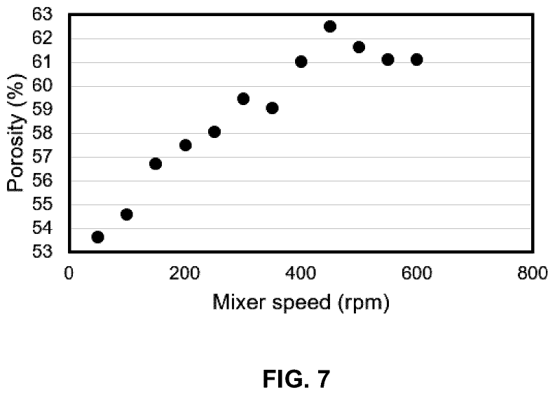

As shown in FIG. 6, porosity of each structure was measured for the 3D printed structures formed in FIG. 7, structures formed with the ink having a mixer speed between 50 rpm and 600 rpm (x-axis). As seen in the images of FIG. 7, the porosity of the structures increased with increasing mixer speed, from 50 rpm to 450 rpm, then at mixer speeds above 450 rpm, the porosity of the 3D printed structure decreased. Without wishing to be bound by any theory, it is believed that at higher mixer speeds, e.g., greater than 450 rpm, excessive heat is generated and increases crosslinking in the ink before extrusion, thereby causing the bubble to be fixed in place, and preventing further formation or growth of bubbles from the mixing. Thus, in some approaches, there may be a maximum mixer speed for forming a maximum porosity.

The degree of mixing of the ink at varying mixer speeds was assessed by adding a dye to one part of a two part ink mixture. As shown in FIG. 8, a series of images show the progression of mixing in 3D printed structures with increasing mixer speed during extrusion of the filaments forming the structure. The following images were taken at different mixer speeds: (a) a mixer speed of 50 rpm, (b) a mixer speed of 100 rpm, (c) a mixer speed of 150 rpm, (d) a mixer speed of 200 rpm, (e) a mixer speed of 250 rpm, (f) a mixer speed of 300 rpm, (g) a mixer speed of 350 rpm, (h) a mixer speed of 400 rpm, (i) a mixer speed of 450 rpm, (j) a mixer speed of 500 rpm, (k) a mixer speed of 550 rpm, (l) a mixer speed of 600 rpm, (m) a mixer speed of 650 rpm, (n) a mixer speed of 700 rpm, (o) a mixer speed of 750 rpm, and (p) a mixer speed of 800 rpm.

As shown, mixing efficiency increases with mixer speed until about a mixer speed of 550 rpm. Mixing efficiency was assessed by degree of homogeneity of the filament material (e.g., striping due to unmixed dye). At mixer speeds above 550 rpm, the shading of the filaments appeared to be homogenous, and the degree of shading did not change at mixer speeds greater than 550 rpm. (see (k) though (p)).

3D Printed Structures Having Alternate Portions of Porosity

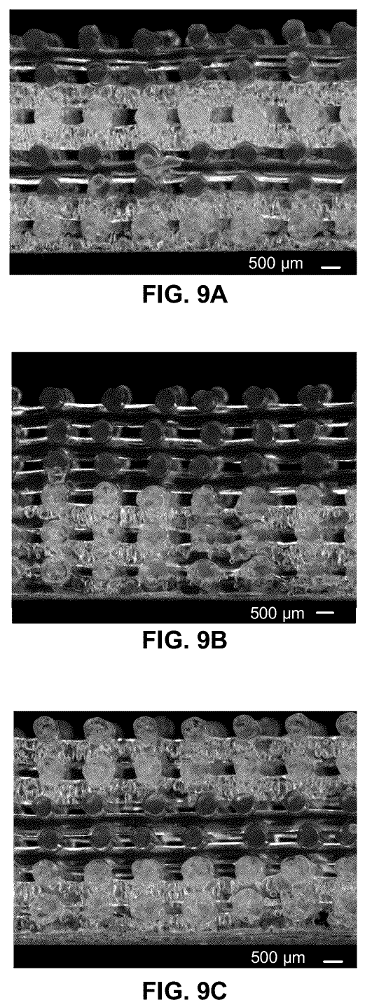

FIG. 9A is an image of a side view of a portion of a 3D printed structure having 3 layers of high porosity in which the mixer speed was 450 rpm, followed by 3 layer of low porosity in which the mixer speed was 50 rpm, in an alternating pattern. The layers having high porosity filaments show a plurality of closed cell pores whereas the layers having low porosity filaments do not show any closed cell pores.

FIG. 9B is an image of a side view of a portion of a 3D printed structure having 6 layers of high porosity in which the mixer speed was 450 rpm, followed by 6 layers of low porosity in which the mixer speed was 50 rpm. The lower portion of the 3D printed structure has high porosity filaments demonstrating a plurality of closed cell pores and the upper portion of the 3D printed structure has low porosity having an absence of closed cell pores in the filaments.

FIG. 9C is an image of a side view of a portion of a 3D printed structure of a set of 4 layers of low porosity filaments sandwiched between 4-layer sets of high porosity. The first set of 4-layers were extruded with ink set to a mixing peed of 450 rpm, then the mixing speed was changed to 50 rpm to reduce the porosity to very low porosity (e.g., essentially no bubbles formed during mixing), and a set of 4-layers was extruded above the layers of high porosity filaments. Then, the mixing speed was changed back to 450 rpm to increase the mixing to form bubbles in the extruded ink. A set of 4-layers of high porosity filament was extruded above the set of 4-layers of low porosity.

Stress Versus Strain of 3D Printed Structures Having Variable Porosity.

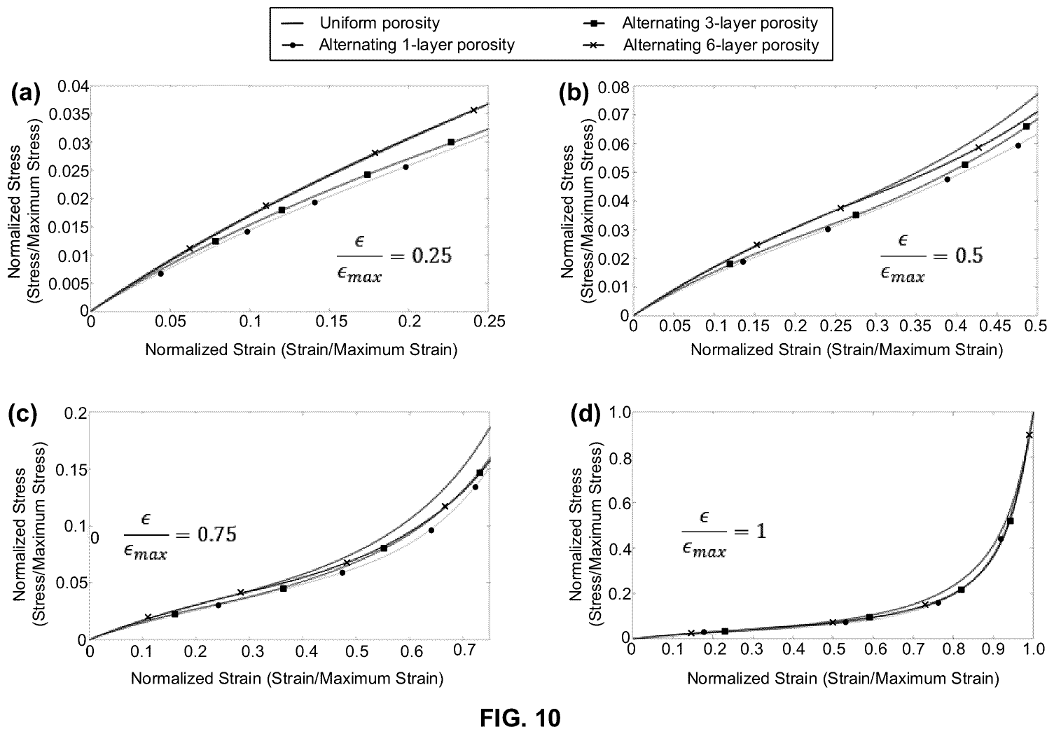

FIG. 10 part (d) represent a plot of normalized stress versus normalized strain of 3D printed structures having varying portions of filament porosity. Different 3D printed structures were compared: (solid line) a 3D printed structure with uniform porosity (59%) extruded at a mixing speed of 350 rpm, (●) a 3D printed structure having alternating 1-layer (mixing speed 50 rpm for one layer, mixing speed 450 rpm for next layer, etc.) (see image of FIG. 2A), (▪) a 3D printed structure having alternating 3-layers (3-layers at mixing speed 450 rpm, 3-layers at mixing speed 50 rpm, etc.) (see image of FIG. 9A), and (X) a 3D printed structure having alternating 6-layers (6-layers at mixing speed of 450 rpm, 6-layers at mixing speed 50 rpm, etc.) (see image of FIG. 9B).

To assess the normalized stress versus the normalized strain of each structure tested in FIG. 10, parts (a), (b), and (c) are expanded portions of the plot in part (d). Part (a) shows the normalized strain from 0 to 0.25. The 3D structures having alternating 1-layer (●) and alternating 3-layer (▪) demonstrate lower values of normalized stress at these lower levels of strain compared to the structures with uniform porosity and alternating 6-layers.

Part (b) shows the normalized strain up to 0.5 of each structure, which demonstrates some differences between each structure. The structure having uniform porosity demonstrates the highest values of normalized stress, and the structure having alternating 1-layer has a lower values of a normalized stress response.

Part (c) shows the normalized strain up to 0.75 which demonstrates the structure having uniform porosity demonstrates higher normalized stress at a normalized strain between 0.5 to 0.75 compared to the three structures having alternating layers of porosity.

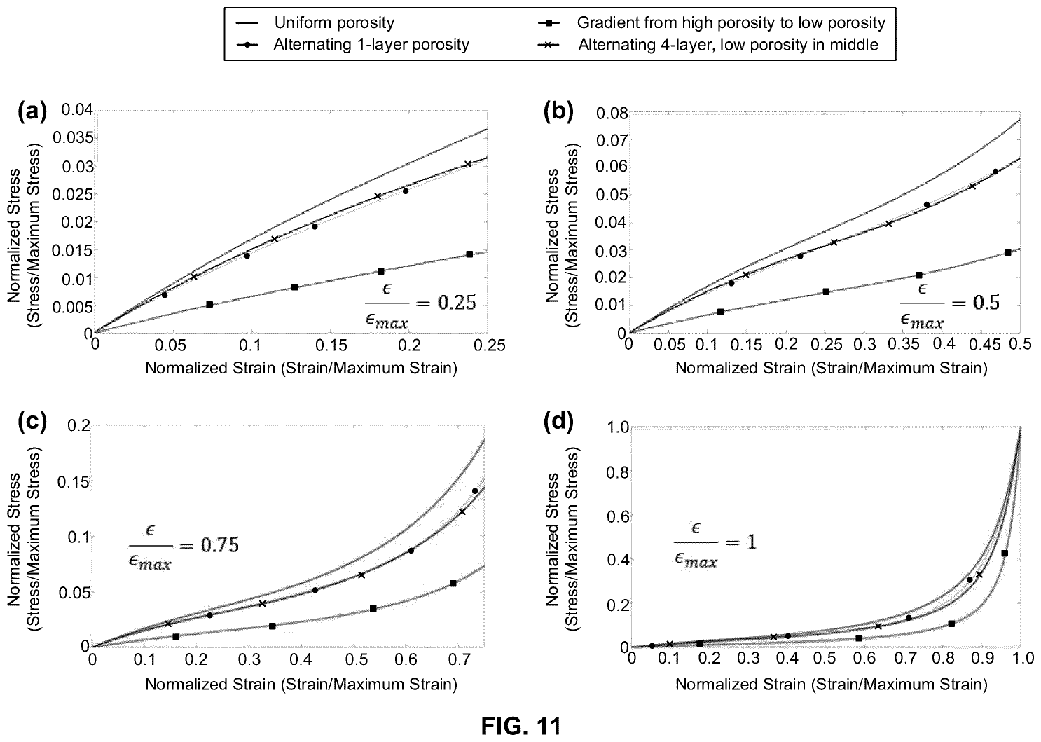

FIG. 11 part (d) represent a plot of normalized stress versus normalized strain of 3D printed structures having varying portions of filament porosity. Different 3D printed structures were compared: (solid line) a 3D printed structure with uniform porosity (59%) extruded at a mixing speed of 350 rpm, (●) a 3D printed structure having alternating 1-layer (mixing speed 50 rpm for one layer, mixing speed 450 rpm for next layer, etc.) (see image of FIG. 2A), (▪) a 3D printed structure having gradient of porosity from high porosity to low porosity (see image of FIG. 2B, 2 layers each of mixing speed 450, 350, 250, 150, and 50 rpm), and (X) a 3D printed structure having alternating 4-layers (low porosity 4-layers, at mixing speed 50 rpm, sandwiched between sets of 4-layers at mixing speed of 450 rpm) (see image of FIG. 9C).

To assess the normalized stress versus the normalized strain of each structure tested in FIG. 11, parts (a), (b), and (c) are expanded portions of the plot in part (d). Part (a) shows the normalized strain from 0 to 0.25. The 3D structures having alternating 1-layer (●) and alternating 4-layer (X) demonstrate lower values of normalized stress at these lower levels of strain compared to the structures with uniform porosity. The 3D printed structure having a gradient of porosity (▪) demonstrates the greatest difference in values of normalized stress with increasing strain compared to the other structures. The 3D printed structure having a gradient of porosity maintains low values of normalized stress at increasing values of normalized strain up to greater than 0.95 (see parts (a), (b), (c), and (d)). The slope of the curve for the structure having a gradient of porosity only converges at the end of the strain region (1.0).

The 3D structures of alternating 1-layer of porosity (●) and alternating 4-layers of porosity (X) demonstrated similar patterns of stress in response to increasing strain.

In Use

Various aspects of an inventive concept described herein may be developed for elastomeric foams for energy absorption, insoles, helmets, acoustic insulators, medical applications, low-density solid support, etc.

The inventive concepts disclosed herein have been presented by way of example to illustrate the myriad features thereof in a plurality of illustrative scenarios, aspects of an inventive concept, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various aspects of an inventive concept have been described above, it should be understood that they have been presented by way of example only, and not limitation. Thus, the breadth and scope of an aspect of an inventive concept of the present invention should not be limited by any of the above-described exemplary aspects of an inventive concept, but should be defined only in accordance with the following claims and their equivalents.

What is claimed is:

1. A product, comprising:
a three-dimensional printed polymer structure formed from at least one filament,
the three-dimensional printed polymer structure having a plurality of layers arranged in a geometric pattern, the layers being formed from the at least one filament,
wherein the at least one filament comprises a polysiloxane material having a plurality of closed cell pores formed therein.

2. A product as recited in claim 1, wherein the three-dimensional printed polymer structure is a foam having an open cell structure comprising the polysiloxane material having the plurality of closed cell pores therein.

3. A product as recited in claim 2, wherein a total porosity of the foam is greater than 74%.

4. A product as recited in claim 2, wherein a total porosity of the foam is in a range of greater than about 21% to about 95%.

5. A product as recited in claim 1, wherein the plurality of layers includes a first layer and a second layer formed from the at least one filament,
wherein the filament of the first layer has a first porosity, and
wherein the filament of the second layer has a second porosity,
wherein the first porosity and second porosity are different.

6. A product as recited in claim 5, wherein the first and second layers have a same composition.

7. A product as recited in claim 1, wherein the three-dimensional printed polymer structure has a gradient of porosity resulting from each of the layers having a different filament porosity.

8. A product as recited in claim 1, wherein the three-dimensional printed polymer structure has a varying degree of stiffness in an x-y direction and/or a z-direction thereacross.

9. A method of forming a three-dimensional structure having closed cell pores, the method comprising:
selecting a first mixer speed for setting a first porosity of an ink, wherein the ink comprises:
a polysiloxane having at least one vinyl group,
a silane crosslinker,
a catalyst,
a gas blowing agent, and
a thixotropic agent;
mixing the ink at the selected first mixer speed;
extruding the ink having the first porosity at a first extrusion rate for forming a first portion of the three-dimensional structure; and
curing the extruded ink in the three-dimensional structure to at least a predefined extent.

10. A method as recited in claim 9, comprising after extruding the ink having the first porosity,
changing the first mixer speed to a second mixer speed for setting a second porosity of the ink that is different than the first porosity; and
extruding the ink having a second porosity at the first extrusion rate for forming a second portion of the three-dimensional structure.

11. A method as recited in claim 10 wherein the first portion and the second portion have higher and lower porosities relative to each portion.

12. A method as recited in claim 10, wherein the first portion is a first layer and the second portion is a second layer above the first layer in a z-direction across the three-dimensional structure.

13. A method as recited in claim 10, wherein forming the three-dimensional structure including an alternating pattern of first and second portions extruded in a x-y direction and/or z-direction thereacross.

14. A method as recited in claim 10, wherein the first and the second portions form a gradient of porosity in the three-dimensional structure, wherein a composition of the first and second portion is the same.

15. A method as recited in claim 14, wherein the gradient of porosity is formed in a step-wise pattern of a plurality of portions having different porosities.
